(19) United States
(12) Patent Application Publication
(10) Pub. No.: US 2006/0210023 A1
(43) Pub. Date: Sep. 21, 2006

(54) Voice messenger LX100

(76) Inventor: Larry Spruce, Columbus, OH (US)

Correspondence Address: LARRY SPRUCE, Apt. 2-F, 35 South Hamilton Rd., Columbus, OH, 43213, US

(21) Appl. No.: 10/998,330

(22) Filed: Feb. 24, 2005

(51) Int. Cl. H04M 1/64

(52) U.S. Cl. 379/67.1; 379/88.01

(57) ABSTRACT

The Voice Messenger is a multifunction communication device that records and plays video, and diplays text messages. The function of the device provides a clutter-free and consolidated point of message delivery and retrieval within a home or office setting. Through simple touch or voice commands, messages can be recorded for single or group recipients. All forms of message data are clustered encoded, prioritized, and stored for later disposition by each recipient. Its notification features allow users to audibly and visually recognize message activity from the panel of the device. The casing and touchpad are covered in a durable plastic that protects the device against dirt and damages, The Voice Messenger can easily be mounted on the wall or be stabilize in another designated location area for easy access.

### CROSS-REFERENCES TO RELATED APPLICATION

Not Applicable

### FEDERAL SPONSORED RESEARCH AND DEVELOPMENT

Not Applicable

### SEQUENCE LISTING OR PROGRAM

Not Applicable

### BACKGROUND

1. Field of Invention

This invention relates to communicating messages from on person to another, that will alleviate miss messages.

2. Description of Prior Art

The way we leave messages for someone in our home has become Somewhat unreliable do to the method we choose.

In some average home today, the most common place to leave a message will be on a desk, or on the refrigerator or by some other designate area in the resident. By doing so there is a great possibility, and chance, that the message might not be noticeable, especially if there are for kids. Kids generally don't pay any attention enough to thing of that nature especially if it's a reminding them of their homework or chores. You most definitely don't want an important message to go unnoticed or unrecognizing under any circumstances because if it do, it may not be disapointing. A message can go unnoticeable if it is not isolated or stand out in its designated area, in any other cast, most likely it will not be seen or notice. Sometime when you leave notices on the refrigerator it can cause problems such as it won't stick and fall off and get possibly loss or miss place it also can be confuse with other notices and reminders that is also stuck on the fridge.

Well with those complication in mind there is a remedy, and I believe It's the Voice Messenger. This product is especially design to prevent messages from being undetected or go unnoticed. It is a multifunctional device that is simple and easy to use. The Voice Messenger can be place very easily mounted on the wall or on a table some where noticeable. VM muti feature allows each person to be designated to a track, that track and that track only belongs to that person. When that person has a message the track light features blinks to indicate that a message has been sent to a recipient. Since the Voice Messenger is a multifunctional device it has many feature a. it can store message in an encoded system. b There's three types of messages available, video, text and voice. c. You can save or delete messages just to name a few. The voice messenger can be place in a stationary place and that will be the focus point for leaving messages, no more trying to find a place to leave a message and I think that one of the main attraction of the voice messenger its easy to identify with.

### REFERENCE TO A MICROFICHE APPENDIX

Not Applicable

### SUMMARY

The voice Messenger is a multifunction communication device that records and plays video and displays text messages. The function of the device provides a clutter-free and consolidated point of message to delivery and retrieval within a home or office setting. Through simple touch or voice commands, messages can be recorded for simple or group recipients. All forms of messages data are clustered encoded, prioritized and stored for later disposition by each recipient its notification allows users to audibly and visually recognize message activity from the panel of the device. The casing and touch pad are covered in a durable plastic the protects the device against dirt and damages.

### BRIEF DESCRIPTION OF THE SEVERAL VIEWS OF THE DRAWING

FIG. 1A—shows the display screen for which the video message will be Played.

FIG. 2A—shows the display screen for viewing of instruction and reading text messages.

FIG. 3A—shows area of where to type text messages

FIG. 4A—show area where to writ text messages.

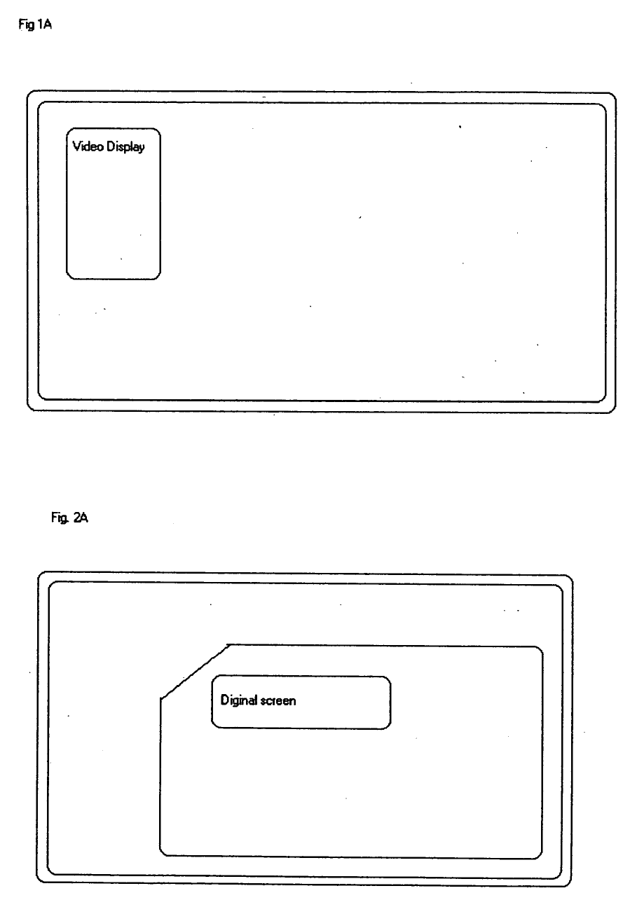

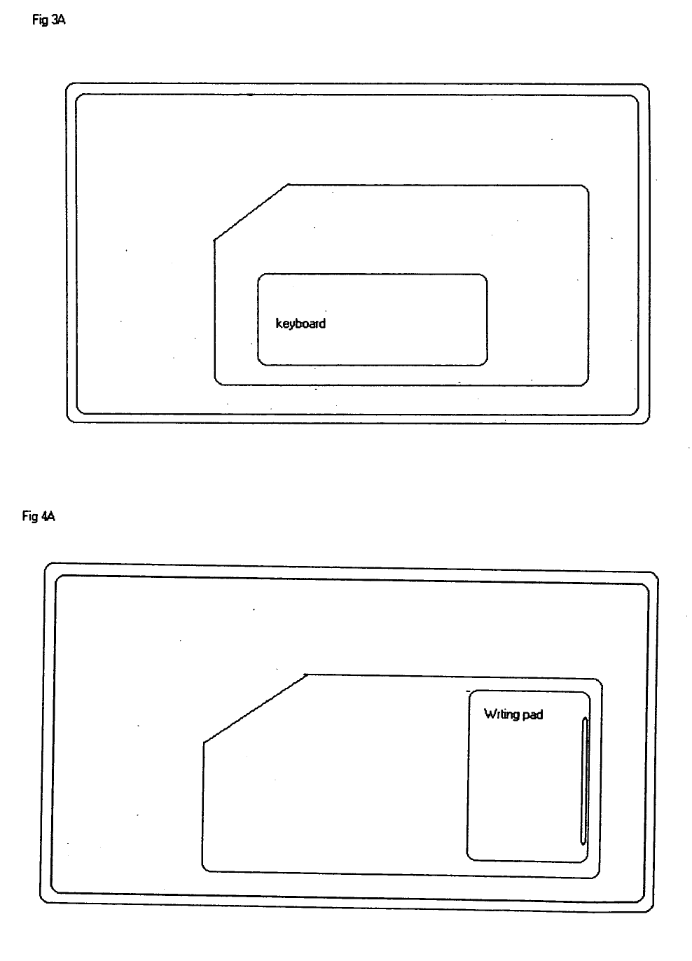

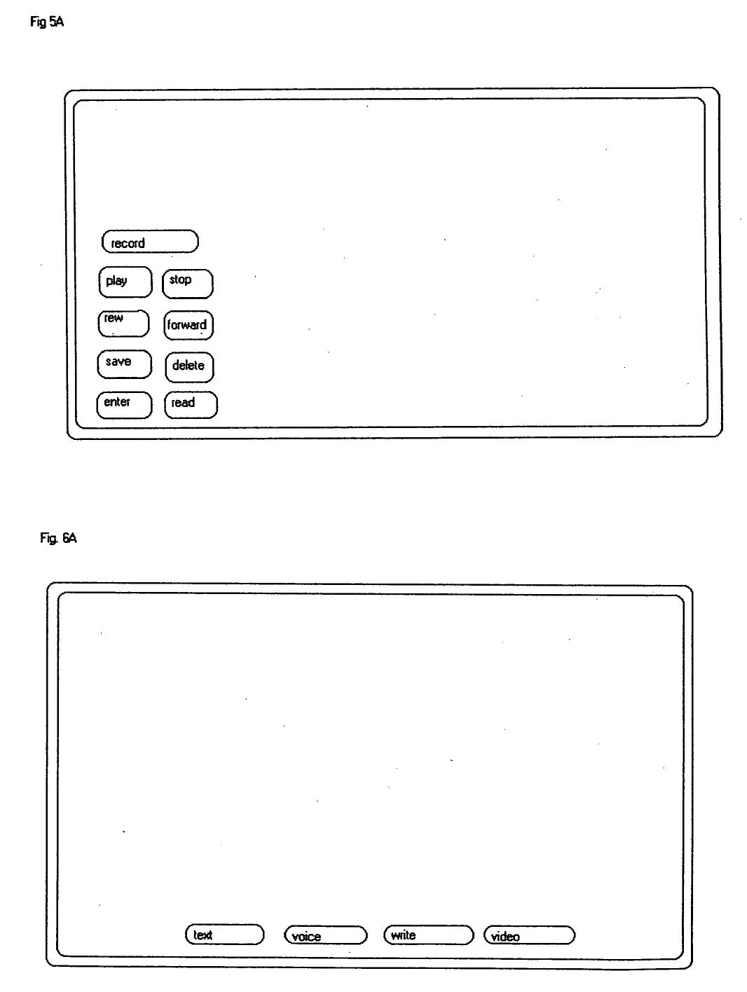

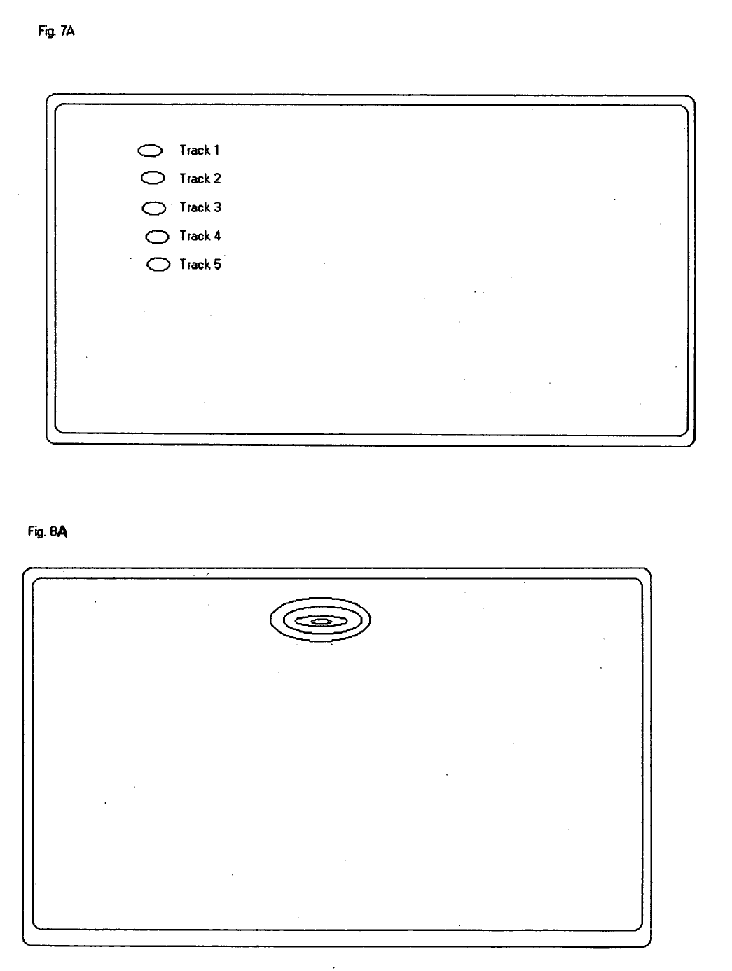

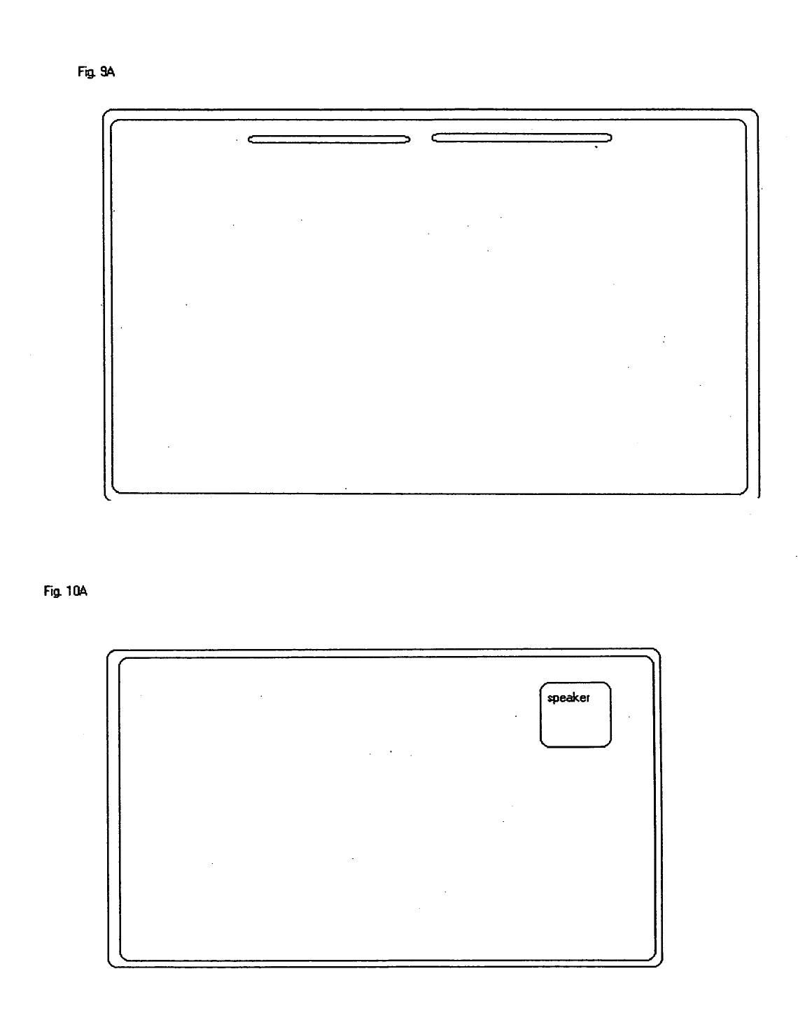

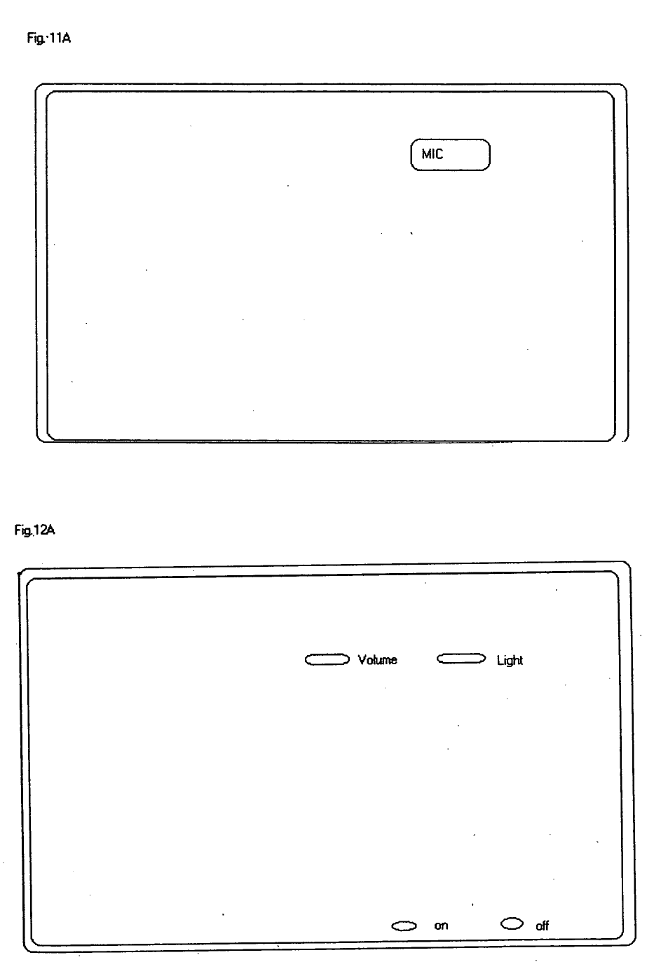

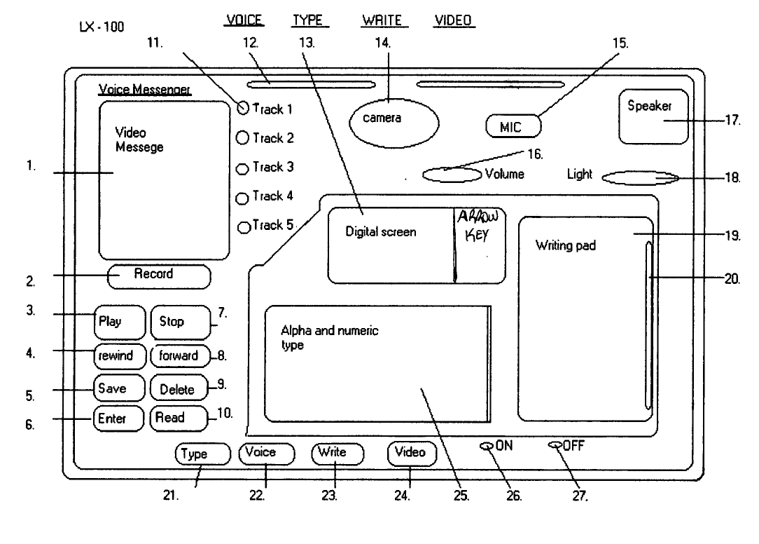

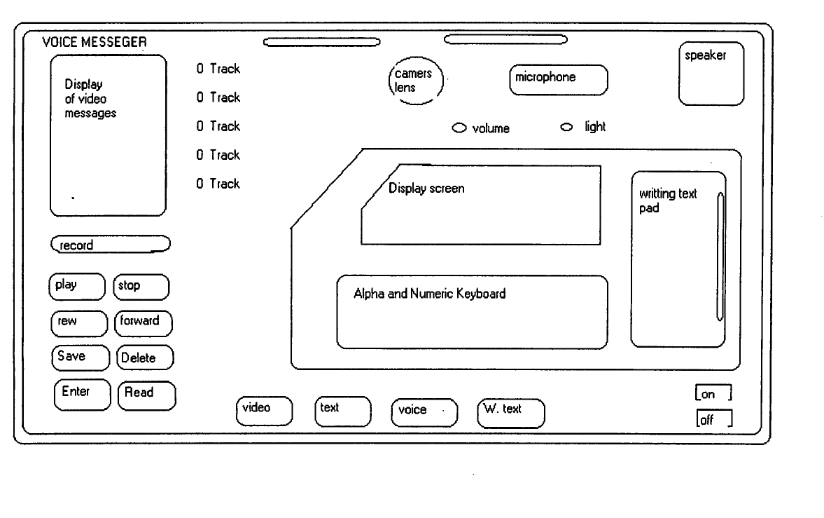

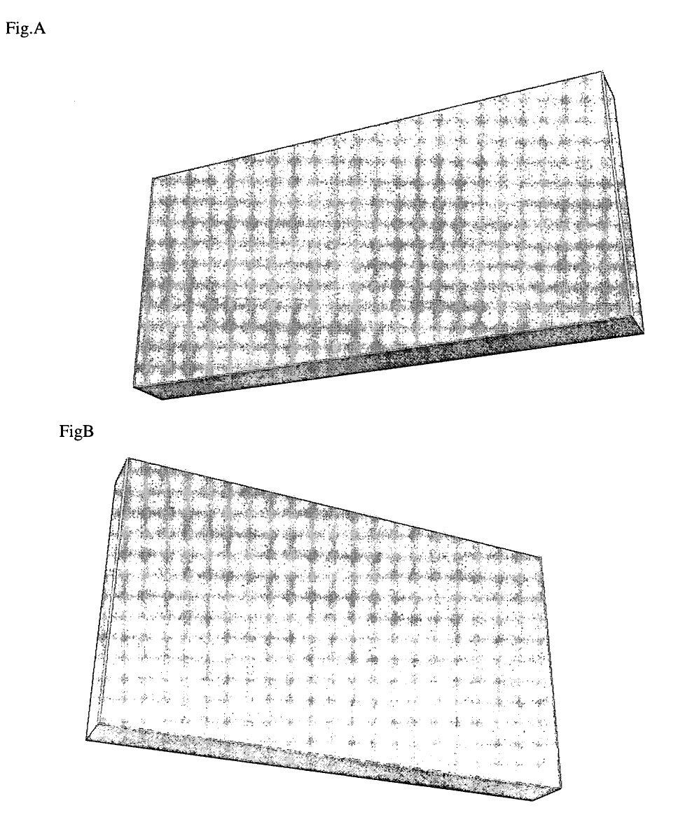

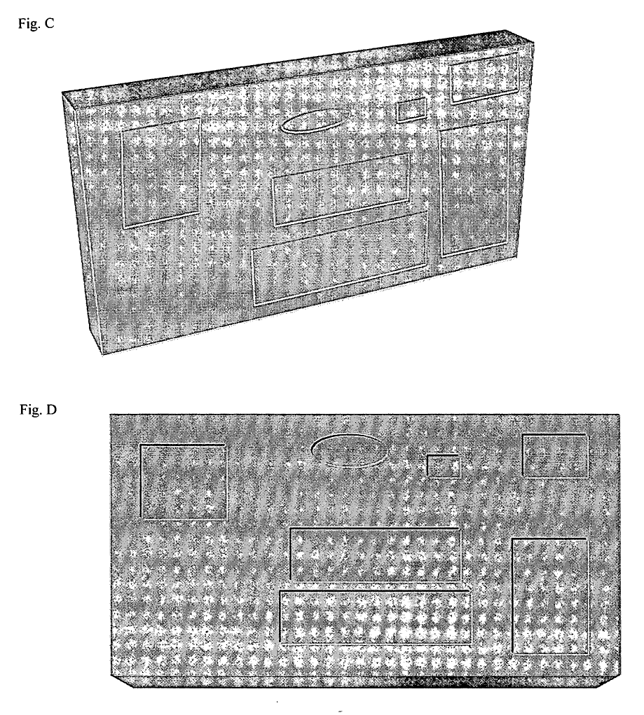

FIG. 5A—shows panel of operational functions
a. Press play to see and hear all voice, and video messages
b. press record to leave video voice or text messages
c. press stop to stop messages from playing
d. press rewind to replay message
e. press forward to forward message
f. press save to save selected messages
g. press delete to delete selected message
h. press read to view text messages
i. press enter to leave recorded messages

FIG. 6A—shows a selection of different type of messages that are available.
a. press text to leave written or type messages
b. press voice to leave a voice messages
c. press video to leave video messages

FIG. 7A—show track indicator to indicate when a recipient has a message

FIG. 8A—show camera lens to capture video messages

FIG. 9A—show lighting beam to give video proper lighting when needed

FIG. 10A—shows speaker to hear all audio

FIG. 11A—show recording microphone

FIG. 12A—shows a variety of functions
a. press volume to increase all audio sound
b. press light to increase the lighting for panel
c. press on to cut device on
d. press off to cut off device

### OJECTS AND ADVANTAGES

Accordingly, besides the objects and advantages of the flexible closures described in my above patent, several objects and advantages of the present invention is:
a. to provide closure that all messages are guaranteed to be receive by recipient
b. to provide closure there are simple instruction on how to operate and use the device
c. To provide closure by setting the device in a certain location make it very accessible and easy to locate
d. To provide closure all messages are encoded do to confidentiality
e. To provide closure person or persons are not limited leave only just one type of message.

Further objects and advantages are to provide a closure which can be used easily conveniently to take and receive messages without losing or missing important information with other methods this assurability is not guaranteed.

### DETAILED DESCRIPTION OF THE INVENTION

The specification shall contain a written description of the invention, and of the manner of using it, in such a full, clear, comcise and exact terms as to enable any person skilled in the art to which it pertains, or with which it is most nearly connected, to use the same, and shall set forth the best mode contempasted by the inventor of carrying out the invention. How to play your messages: press the blinking track light 11 that indicate when recipient have massages.then press your code, (each track has a code for privacy reasons.) to reveal the messge or messages that you have waiting to be viewed, then the display screen 13 will display all type of messages that has been delivered to your track. If you have more than one message, then you have the option to scroll down and up to view those different types of messages. Recording a message: first you would press record 2 press what type of message you want to send 21, 22, 23, or 24 after leaving your press enter 6 to send it. Deleting messages: press track you wish to enter 11 enter your code (the code that has been set by you) scroll to message you want to delete press delete 9 to delete all and any message you so desire. Saving your messages: after receiving or viewing a message press save 5 keep information. You can save all and any messages you so desire.

### Operation of Invention

Press play 1 to activate audible message or messages, press stop 7 to end to cease message, press rewind 4 to go backward in message, press forward to go ahead in message, press save 5 to save information for later review, press delete 9 to get rid of unwanted information, press enter 6 to enter message for recipient, press read 10 to display text messages, press record 2 to leave a voice, text, written, and video for recipient to retrieve, press on 26 to turn power device on, press off 27 to shut off power device, press voice 22 to leave audible message for recipient, press type 21 to leave keyboard text message for recipient, press video 24 to leave an audible visual message for recipient, press write 23 to leave a written text for recipient; press light 18 to light panel on apparatus, press volume to increase all audible information, press track 11 to leave message for recipient and for recipient to retrieve information or messages, and press arrow key for scrolling purposes only, 14 is the camera lens to capture image for video data, 15 is the microphone for audible purposes only, 17 is the speaker to hear all audible information, 20 the utincil touse to write written text, 19 the area to write witten text.

### DRAWINGS

Front full view that shows a full figure of device, Numbered view that shows each part by numbers, FIG. A1 shows top left angle of device, FIG. B2 shows bottom right angle. FIG. C3 shows top right angle of device, FIG. D5 show full

I claim:

1. An information recording apparatus device that records three kind of messages video, text and voice. Recording on a record medium recorder for residential use only. A encoding system that stores message to be later retrieve by recipient.
Displaying of text images of said recording data information of a recording that can be retrieve by said recipient. Display image recording for said recipient.
Allows person or persons to use apparatus to leave message on apparatus for designated recipient.
Blinking track light on apparatus to indicate message for designated recipient.
Apparatus has camera that allows person or persons to leave or retreive video message.
Apparatus has a writing pad on that allows person or persons to write message for designated recipient.
Apparatus has a keyboard that allows person or persons to leave text messages for designated recipient.
Digital screen displays particularly all instruction of how to operation all aspect of apparatus.
Person or persons can speak into the microphone of said apparatus to leave audible message for designated recipient.
Apparatus provides proper lighting for adequate video images to be recorded.
Apparatus has the capability to encode and cluster information to be reviewed by recipient.
Automated Instruction on how to operate the the device.
